(19) United States
(12) Patent Application Publication
(10) Pub. No.: US 2007/0221794 A1
(43) Pub. Date: Sep. 27, 2007

(54) Mounting arm

(76) Inventor: Chin-Chu Li, Taipei (TW)

Correspondence Address: CHIN-CHU LI, P.O. BOX 26-757, TAIPEI, 106, TW

(21) Appl. No.: 11/387,043

(22) Filed: Mar. 21, 2006

(51) Int. Cl. F16M 13/00

(52) U.S. Cl. 248/124.1

(57) ABSTRACT

A mounting arm is used to support the thin type electronic products such as thin type computer or flat panel displayer. The mounting arm comprises a bearing base, a first support arm, a second support arm, and a pedestal. The bearing base is fixed on a wall or a pillar, the first support arm is pivotally engaged with the bearing base, the second support arm is pivotally engaged with the first support arm, the pedestal is pivotally engaged with the second support arm, and the pedestal is connected with the thin type electronic product. Furthermore, each of the first support arm and the second support arm has an oblique surface, and the oblique surface of the first support arm faced and mated with the oblique surface of the second support arm so as to reduce the occupation space when the second support arm is overlapped up the first support arm.

### BACKGROUND OF THE INVENTION

1. Field of the Invention

The present invention relates to a mounting arm, and more particularly to the mounting arm is used to support a thin type computer or a flat panel displayer.

2. Description of the Prior Art

With birth of the thin type electronic products such as flat panel displayers, liquid crystal displayers, liquid crystal televisions, plasma televisions, and so on, they are not only placed on the table or floor but are fixed on various places such as the wall, ceiling, and so on. Hence, there are many kinds of supporting frameworks or mounting arms are developed to satisfy different requirements of the users.

The conventional mounting arm for supporting these electronic products distinguishes the vertical mounting arm and the hanging mounting arm. The vertical mounting arm is often fixed on the table. It is for changing the height and the angle of the electronic product disposed thereon. The hanging mounting arm is often fixed on the wall. It is used to horizontally and vertically rotate and vertically change the angles of the electronic product disposed thereon.

The hanging mounting arm is retracted and folded, however, a support arm of the hanging mounting arm doesn't flatly stayed close to the wall so as to have an occupation space.

The inventor of the present invention recognizes the above shortage should be corrected and special effort has been paid to research this field. The present invention is presented with reasonable design and good effect to resolve the above problems.

### SUMMARY OF THE INVENTION

An object of the present invention is to provide a mounting arm, which is flatly stayed close to the wall so as to reduce the occupation space when it is retracted and folded.

For achieving the objective stated above, the present invention provides a mounting arm comprises a bearing base, a first support arm, a second support arm, and a pedestal. One end of the first support arm is pivotally engaged with the bearing base, and a pivoting element is installed at the other end pivotally engaged with the second support arm; the second support arm is pivotally engaged with the other end of the first support arm pivotally engaged with the pedestal. Each of the first support arm and the second support arm has an oblique surface, and the oblique surface of the first support arm faced and mated with the oblique surface of the second support arm so as to the first support arm is overlapped with the second support arm when the mounting arm is retracted and folded. Furthermore, there is a height difference between two ends of the first support arm and the second support arm due to the two oblique surfaces. Hence, there is a small thickness between the first support arm and the second support arm when they overlap. And, the mounting arm is flatly stayed close to the wall so as to reduce the occupation space when it is retracted and folded.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is an exploded perspective view of the present invention;

FIG. 2 is a perspective schematic view of the present invention;

FIG. 3 is a schematic view of the first embodiment of the present invention;

FIG. 4 is a schematic view of the second embodiment of the present invention;

FIG. 5 is a schematic view of the third second embodiment of the present invention; and

FIG. 6 is a schematic view of the fourth embodiment of the present invention.

The drawings will be described further in connection with the following detailed description of the present invention.

### DETAILED DESCRIPTION OF THE PREFERRED EMBODIMENTS

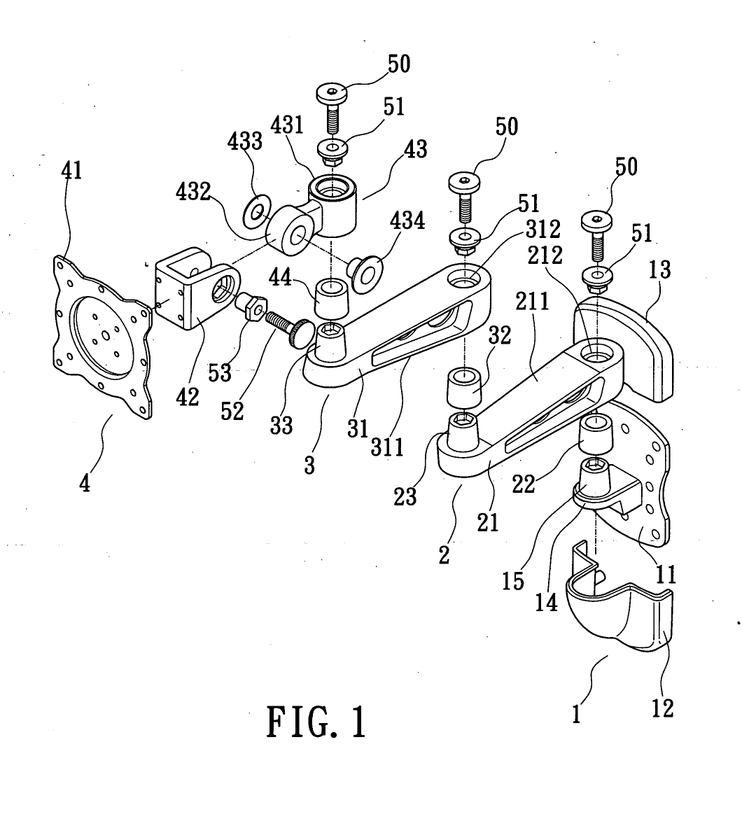

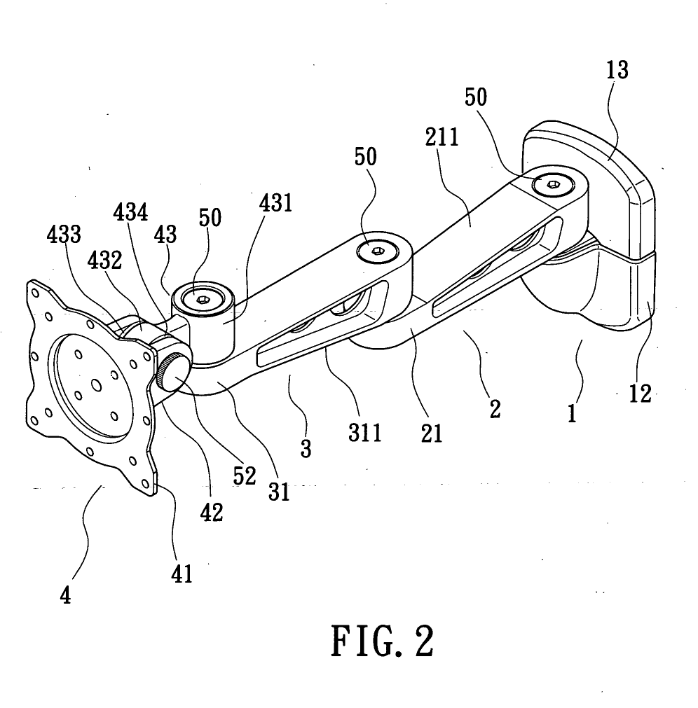

Reference is made to FIG. 1 and FIG. 2. The mounting arm of the present invention has a bearing base 1, a first support arm 2, a second support arm 3, and a pedestal 4. The bearing base 1 has a base 11, a lower casing 12, and an upper casing 13. A holder 14 is extended from the base 11, and a pivoting element 15 is installed on the holder 14. The lower casing 12 and the upper casing 13 are covered with the base 11; a groove is extended from the lower casing 12 for containing the holder 14, and a open of the groove of the lower casing 12 matches the holder 14 make the pivoting element 15 be exposed.

The first support arm is pivotally engaged with the bearing base 1. The first support arm has an arm 21, a sleeve 22, and a pivoting element 23; an oblique surface 211 is disposed on the upward surface of the arm 21 so that one end of the arm 21 is thicker than the other end, the former is pivotally engaged with the bearing base 1. A pivoting hole 212 is installed at one end of the arm 21 that the bearing base 1 pivotally engaged with, and the first support arm 2 is pivotally engaged with the bearing base 1 by the sleeve 22 and the pivoting hole 212, and the pivoting element 23 is installed at the upward surface of the other end of the arm 21.

The second support arm 3 is pivotally engaged with the first support arm 2. The first support arm has also an arm 31, a sleeve 32, and a pivoting element 33; an oblique surface 311 is disposed on the downward surface of the arm 31 so that one end of the arm 31 is thicker than the other end, the former is pivotally engaged with the first support arm 2 so as to the oblique surface 311 of the second support arm 3 faced and mated with the oblique surface 211 of the first support arm 2. A pivoting hole 312 is installed at one end of the arm 31 that the first support arm 2 pivotally engaged with, and the second support arm 3 is pivotally engaged with the first support arm 2 by the sleeve 32 and the pivoting hole 312, and the pivoting element 33 is installed at the upward surface of the other end of the arm 31.

The pedestal 4 is pivotally engaged with the second support arm 3. The pedestal 4 has a connecting board 41, a connecting element 42, a joint 43, and a sleeve 44, and the connecting board 41 is used to connect with the thin type electronic products. The connecting element 42 is inverse U-type, and the middle section is fixed on the connecting board 41, two ends are pivotally engaged with the joint 43. The joint 43 has a hitching portion 431, a pivoting portion 432, a washer 433, and an insertion element 434. The pedestal 4 is pivotally engaged with the second support arm 3 by the hitching portion 431 and the sleeve 44. The pivoting portion 432 is installed in the inside of the connecting element 42, and is pivotally engaged therewith; the washer 433 is padded between the pivoting portion 432 and the connecting element 42, and in one side of the pivoting portion 432; the insertion element 434 is also padded between the pivoting portion 432 and the connecting element 42, but in the other side of the pivoting portion 432 is relative to the washer 433.

Firstly, the sleeve 22 is hitched on the pivoting element 15, and then the pivoting hole 212 of the first support arm 2 is hitched the outside of the sleeve 22, and then a first screw 50 and a first nut 51 are used to lock them so that the first support arm 2 is firmly pivotally engaged with the bearing base 1. The hexagonal first nut 51 is plugged into top of the pivoting hole 212 and located in a hexagonal hole of the pivoting element 23 so that the first nut 51 doesn't be rotated, and then the first screw 50 is used to lock them so that the first support arm 2 can firmly be fixed on the bearing base 1 and only horizontally rotated. Similarly, the sleeve 32 is hitched on the pivoting element 23, and then the pivoting hole 312 of the second support arm 3 is hitched the outside of the sleeve 32, and then a first screw 50 and the first nut 51 are used to lock them so that the second support arm 3 is firmly pivotally engaged with the first support arm 2.

For the pedestal 4, the connecting board 41 is fixed on the middle section of the connecting element 42 by a screw (not shown), and next the washer 433 and the insertion element 434 of the joint 43 are separately installed at two sides of the pivoting portion 432, and next the connecting element 42 is hitched in the outside of the pivoting portion 432, and then a second screw 52 and a second nut 53 are used to lock them so that the connecting element 42 is firmly pivotally engaged with the joint 43. Finally, the sleeve 44 is hitched on the pivoting element 33, and next the hitching portion 431 of the pedestal 4 is hitched the outside of the sleeve 44, and next the first screw 50 and the first nut 51 are used to lock them so that the pedestal 4 is firmly pivotally engaged with the second support arm 3.

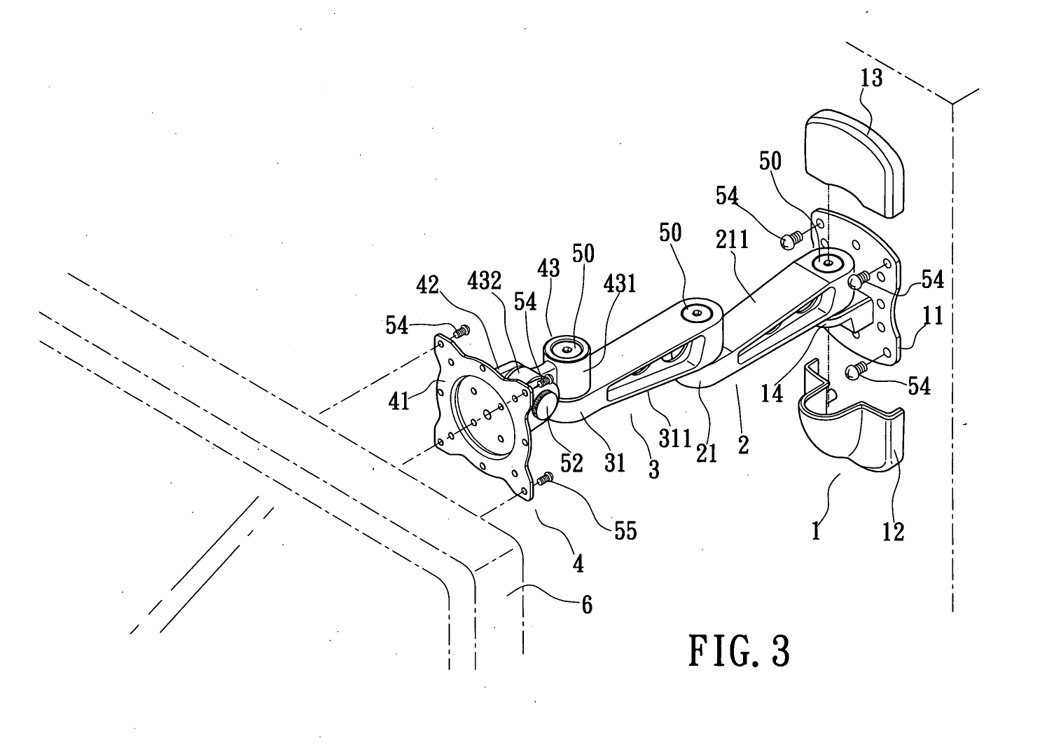

Reference is made to FIG. 3, which is a schematic view of the first embodiment of the present invention. The base 11 is fixed on the wall or the pillar by third screws 54, and then the lower casing 12 and the upper casing 13 are covered with the base 11, and then the mounting arm is assembled in accordance with the steps stated above, and finally the connecting board 41 is fixed with the flat panel displayer 6, the thin type computer (not shown), or other thin type electronic products (not shown) by fourth screws 55 so as to be hanged on the wall or the pillar. By means of the pivoting relationship between the connecting element 42 and the pivoting portion 432 to vertically upward or downward change the angles of the flat panel displayer 6, the thin type computer, or other thin type electronic products; the pivoting relationship between the bearing base 1, the first support arm 2, the second support arm 3, and the pedestal 4 to horizontally rotately change the angles of the flat panel displayer 6, the thin type computer, or other thin type electronic products.

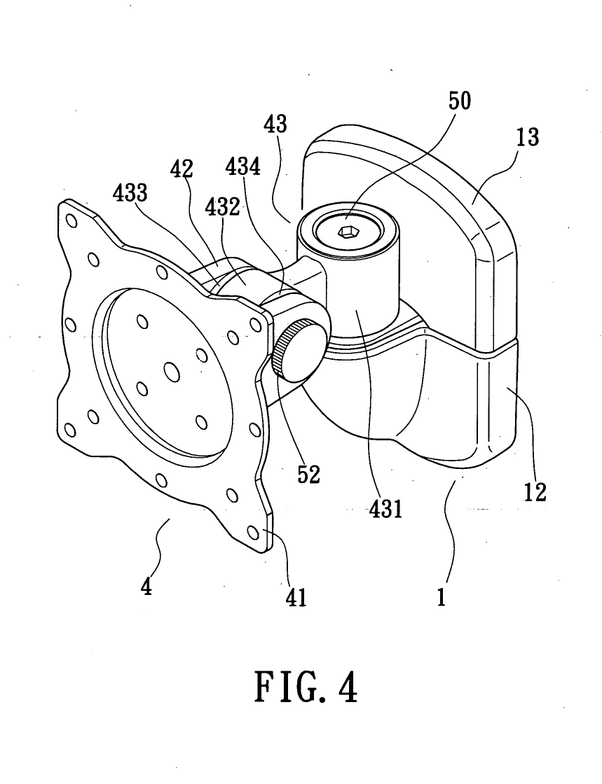

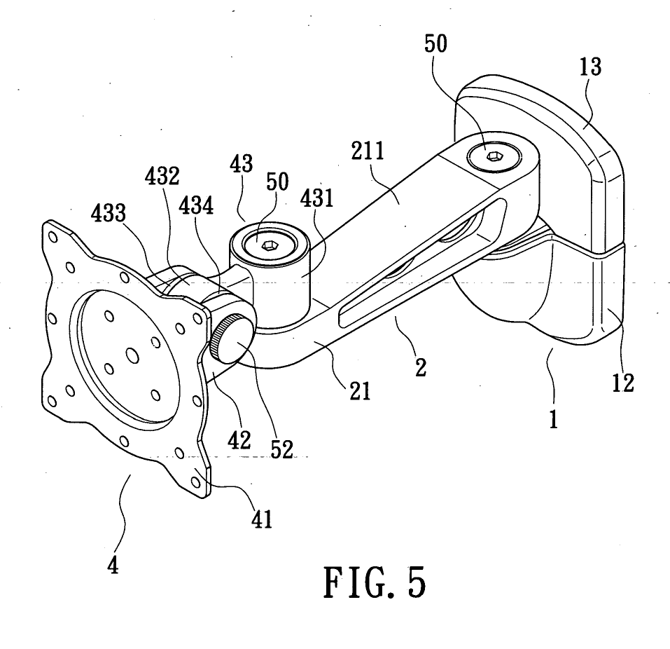

Reference is made to FIG. 4 and FIG. 5. In order to reduce the occupation space, the mounting arm of the present invention is also to that the pedestal 4 is directly pivotally engaged with the bearing base 1 (shown in FIG. 4) so as to make the arm length of the mounting arm used is only the length of the pedestal 4. In addition, the bearing base 1 is pivotally engaged with the first support arm 2 and the first support arm 2 is directly pivotally engaged with the pedestal 4 without being pivotally engaged with the second support arm 3 (shown in FIG. 5) so as to make the arm length of the mounting arm used is only the length of the first support arm 2 adds the length of the pedestal 4. Of course, it will obtain the same effect that the first support arm 2 is replaced with the second support arm 3.

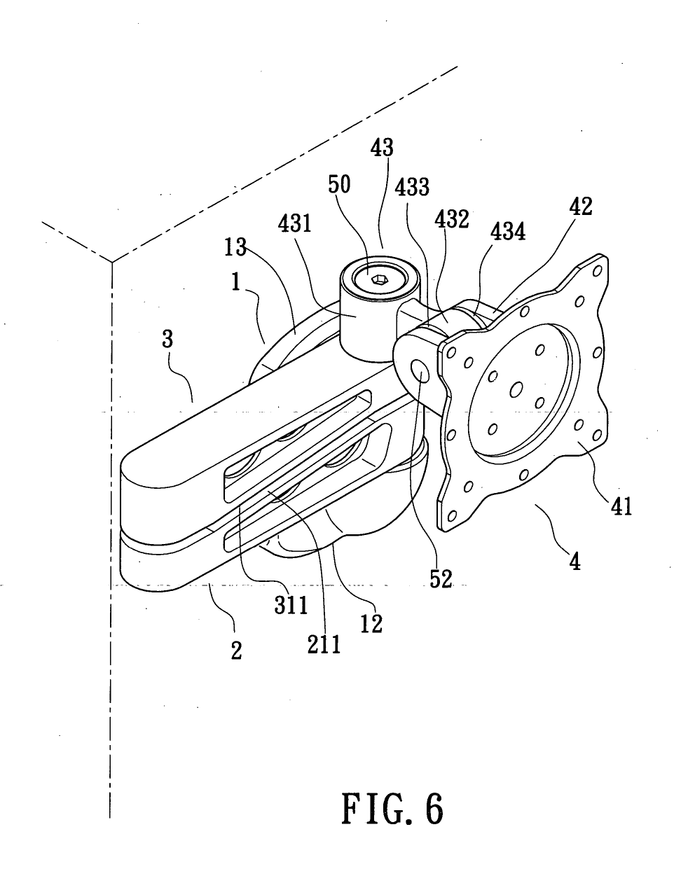

Reference is made to FIG. 6 which is a schematic view of the fourth embodiment of the present invention. The mounting arm is also used to reduce the occupation space even though the bearing base 1, the first support arm 2, the second support arm 3, and the pedestal 4 are mutually pivotally engaged as stated above. When the mounting arm is retracted and folded, the first support arm 2 is overlapped up the second support arm 3 and the mounting arm is flatly stayed close to the wall or the pillar so the arm length of the mounting arm used is only the length of the pedestal 4. In addition, the oblique surface 211 is disposed on the upward surface of the arm 21 so that one end of the arm is thicker than the other end, the former is pivotally engaged with the bearing base 1; the oblique surface 311 is disposed on the downward surface of the arm 31 so that one end of the arm 31 is thicker than the other end, the former is pivotally engaged with the first support arm 2. Furthermore, the oblique surface 311 of the second support arm 3 faced and mated with the oblique surface 211 of the first support arm 2 so that the high end of the first support arm 2 is overlapped up the low end of the second support arm 3 and the low end of the first support arm 2 is overlapped up the high end of the second support arm 3 so as to reduce the occupation space when it is retracted and folded.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mounting arm for supporting a thin type computer or a flat panel display, comprising:
a bearing base;
a first support arm having an oblique surface, one end of the first support arm pivotally engaged with the bearing base;
a second support arm having another oblique surface faced and mated with the oblique surface of the first support arm; one end of the second support arm pivotally engaged with the other end of the first support arm; and
a pedestal pivotally engaged with the other end of the second support arm.

2. The mounting arm as in claim 1, wherein the bearing base has a base, a lower casing, and an upper casing; the base is fixed on a wall or a pillar of a building, the lower casing and the upper casing are covered with the base.

3. The mounting arm as in claim 2, wherein the base further has a holder and a pivoting element; the holder is extended from the base and the pivoting element is disposed on the holder.

4. The mounting arm as in claim 3, wherein the first support arm has a pivoting hole installed at one end thereof and the bearing base pivotally engaged with the first support arm through the pivoting hole; and a pivoting element installed at the other end thereof, the first support arm is pivotally engaged with the pivoting element of the bearing base through the pivoting hole and a first sleeve and the pivoting element of the first support arm is used to pivotally engage with the second support arm.

5. The mounting arm as in claim 4, wherein the second support arm has another pivoting hole installed at one end thereof and the first support arm pivotally engaged with the second support arm through the another pivoting hole; and another pivoting element installed at the other end of the second support arm, the second support arm is pivotally engaged with the pivoting element of the first support arm through the another pivoting hole and a second sleeve and the pivoting element of the second support arm is used to pivotally engage with the pedestal.

6. The mounting arm as in claim 5, wherein the pedestal has a connecting board, a connecting element and a joint, the connecting board is connected with the connecting element, the joint has a hitching portion installed at one end thereof and a pivoting portion installed at the other end thereof, the pivoting portion is pivotally engaged with the connecting element, and the pedestal is pivotally engaged with the second support arm by the hitching portion and a third sleeve.
